(19) United States
(12) Patent Application Publication
(10) Pub. No.: US 2020/0368893 A1
(43) Pub. Date: Nov. 26, 2020

(54) Kitchen Knife with Easily Replaced Knife Handle Sheath

(71) Applicant: Yangdong Halbert Knife Manufacture Co., Ltd., Yangjiang (CN)

(72) Inventor: Changming Chen, Yangjiang (CN)

(21) Appl. No.: 16/548,871

(22) Filed: Aug. 23, 2019

(30) Foreign Application Priority Data
May 20, 2019 (CN) 201910420700.9

(51) Int. Cl. B25G 3/26; B26B 3/00

(52) U.S. Cl. CPC B25G 3/26; B25G 1/10; B26B 3/00

(57) ABSTRACT

A kitchen knife with a detachable knife handle sheath, the kitchen knife including a blade, a knife handle, a one-piece integrally formed knife handle sheath, and only one fastening bolt, wherein the knife handle sheath includes a first clamping portion and a second clamping portion connected to each other, an engaging groove fitted with the knife handle is provided between the first clamping portion and the second clamping portion, and the knife handle is inserted into and fixed to the engaging groove. The only one fastening bolt passes through a through hole of the knife handle sheath and a fixing hole of knife handle to fasten the knife handle sheath outside the knife handle. A method of replacing the knife handle sheath of a kitchen knife is also disclosed. The knife handle sheath is easy to be installed and removed and is convenient for replacement.

### CROSS REFERENCE TO RELATED APPLICATIONS

The present application claims the benefit of Chinese Patent Application No. 201910420700.9 filed on May 20, 2019, the contents of which are incorporated herein by reference in their entirety.

### TECHNICAL FIELD

The present invention relates to the technical field of knives, particularly to a kitchen knife, and more particularly to a kitchen knife with an easily replaceable knife handle sheath.

### BACKGROUND ART

During the use of a knife, a blade often comes into contact with fresh meat, fruits and vegetables, so that it is inevitable that the knife will be exposed to bacteria during the contact, and thus the knife needs to be thoroughly cleaned before and after use. If the knife cannot be dried in time after cleaning, bacteria still grow. So, in most western countries, people prefers to put the knife into a dishwasher with a function of cleaning at a high temperature for cleaning and sterilization.

At present, the market-available knives need to be discarded after being used for a certain number of years, and in a considerable number of countries, items to be discarded should be classified and discarded based on materials. The materials of the items are generally classified into metal, cardboard, wood, glass, plastic, etc. In terms of environmental protection, in the requirement for sub-classification of garbage, it is preferable to separately recycle the knife handle sheath and the blade such that the knife handle sheath (wood, plastic, etc.) and the stainless steel or ceramic blade are discarded and recycled based on different types of material so as to reduce the disposal capacity of garbage, reduce the disposal cost, reflect the resource, economic and ecological benefits and achieve full utilization of resources.

However, in a market-available knife at present, the knife handle sheath is firmly fixed on the knife handle, such that it is impossible to remove the knife handle sheath when the knife is cleaned, and it is cumbersome and even difficult to remove the knife handle sheath when the knife is recycled. In the prior art, since the material of the knife handle sheath is different from that of knives made of a metal material, the materials have different speeds of thermal expansion and contraction, and it is inevitable that the knife handle sheath (handle) gets cracking, aging, fading, etc. when the knife is repeatedly cleaned in a dishwasher. In addition, for the market-available knives at present, consumers still cannot choose a knife handle sheath of different materials in different climates or replace the knife handle sheath according to their own preferences, especially when using a steak knife at parties, cannot replace the knife handle sheath with a knife handle sheath of a different colour or material such that it is impossible to replace a blade due to the blade being blunt or aged or when the blade is desired to be replaced for changing the type of blade, such as replacing the blade with a blade subjected to stainless steel sanding, titanium coating and painting, water transfer printing or pattern printing. In addition, for the existing knives, it is impossible to keep the handle and directly purchase a blade for assembly.

Furthermore, among the existing products, the market-available knives at present cannot meet the needs of consumers, and the manner in which several blades different in size or shape share one knife handle sheath is inconvenient to implement in the existing market-available products, and the manner to directly replace a handle when it is aged is not easy to implement, resulting in the waste of resources and energy due to the production of knives different in size or shape, so that it is impossible to achieve the energy-saving effect.

Therefore, it is necessary to design a knife with an easily detachable knife handle sheath to meet the new demands of the market.

### SUMMARY OF THE INVENTION

The technical problem to be solved by the present invention is to provide a kitchen knife with an easily replaceable knife handle sheath, by which the knife handle sheath of the kitchen knife can be detached quickly and replaced easily.

In order to solve the above technical problem, the technical solution of the present invention is as follows:

a kitchen knife with an easily replaceable knife handle sheath, the kitchen knife including a blade, a knife handle, a one-piece integrally formed knife handle sheath, and only one fastening bolt, wherein the knife handle sheath includes a first clamping portion and a second clamping portion connected to each other, an engaging groove fitted with the knife handle is provided between the first clamping portion and the second clamping portion, and the knife handle is inserted into and fixed to the engaging groove.

Preferably, the kitchen knife is a single bolster knife or a knife with a stamped blade and knife handle structure.

Preferably, the knife handle is provided with a fixing hole and the only one fastening bolt for fixing the knife handle sheath, and the fixing hole is internally provided with a thread, the only one fastening bolt is provided with an external thread which is in threaded engagement with the thread in the fixing hole; and the knife handle sheath is provided with a through hole that is in registration with the fixing hole, the diameter of the through hole is the same as that of the fixing hole, and the only one fastening bolt passes through the through hole and the fixing hole to fasten the knife handle sheath outside the knife handle.

Preferably, the knife handle is provided with a slot, a partition bar fitted with the slot is provided in the middle of the engaging groove, and the partition bar is inserted into the slot to fix the knife handle sheath. Since the partition bar is provided in the middle of the engaging groove, the partition bar is embedded in the slot of the knife handle that is fitted to the partition bar, and the partition bar is clamped by two ends of the slot to fix the knife handle sheath, thereby enhancing the stability of the knife handle sheath and increasing the contact area between the knife handle and the knife handle sheath so that the knife handle sheath is not tend to be detached from the knife handle.

Preferably, the width of the partition bar is 0.2-1 mm smaller than the width of the slot.

Preferably, it further includes only one fastening bolt that passes through the through hole and the fixing hole to further fastens the knife handle sheath outside the knife handle.

Preferably, the kitchen knife is a single bolster knife, the lengths of the blade, the knife handle and the knife handle sheath are respectively 200 mm, 140 mm and 116 mm, the maximum width of the blade is 2.7 mm, the width of the knife handle sheath is 19 mm, and the distance between the first clamping portion and the second clamping portion is 3.5 mm, and the height of the partition bar is 3.5 mm.

Preferably, the lengths of the kitchen knife is a knife with a stamped blade and knife handle structure, the stamped blade, the stamped knife handle and the knife handle sheath are respectively 133 mm, 115 mm and 115 mm, the maximum width of the blade is 1.5 mm, the width of the knife handle sheath is 12 mm, and the distance between the first clamping portion and the second clamping portion is 1.5 mm.

Preferably, the material of the blade and the knife handle is stainless steel or ceramic, and the material of the knife handle sheath is wood, plastic, rubber, stainless steel, ceramic or a G10 composite material.

Preferably, an entire outer peripheral edge surface of the knife handle is flush with an outer surface of the knife handle sheath to form an entire handle with a smooth contour. The technical solution of the present invention also involves: a method of replacing a knife handle sheath of a kitchen knife, the method including: removing the only one fastening bolt from the through hole and the fixing hole; and pulling the knife handle sheath out from the knife handle, and thus at the same time pulling the partition bar out from the slot, thereby detaching the knife handle sheath from the knife handle.

The method further includes: installing the knife handle sheath or a new knife handle sheath back to the knife handle; and fastening the knife handle sheath or the new knife handle sheath to the knife handle by the only one fastening bolt.

With the above technical solution, since the engaging groove fitted with the knife handle is provided between the first clamping portion and the second clamping portion of the knife handle sheath, the knife handle sheath is easy to be installed and detached and is convenient for replacement.

### BRIEF DESCRIPTION OF THE DRAWINGS

FIG. 1 is a structural schematic diagram of a single bolster knife having a transverse knife handle in Embodiment I of the present invention when a knife body is separated from a knife handle sheath;

FIG. 2 is a top view of the single bolster knife in Embodiment I of the present invention;

FIG. 3 is a front view of the single bolster knife in Embodiment I of the present invention;

FIG. 4 is a cross-sectional schematic diagram taken in a direction A-A in FIG. 3;

FIG. 5 is a structural schematic diagram of a single bolster knife having a vertical knife handle in Embodiment I of the present invention when a blade is separated from a knife handle sheath;

FIG. 6 is a structural schematic diagram of a knife with a stamped blade and knife handle structure in Embodiment II of the present invention when a knife body is separated from a knife handle sheath;

FIG. 7 is a perspective structural schematic diagram of a knife handle sheath of the knife with a stamped blade and knife handle structure in Embodiment II of the present invention.

In the figure, 10—blade, 11—bolster, 20—knife handle, 21—slot, 23—fixing hole, 30—knife handle sheath, 31—engaging groove, 33—through hole, 35—first clamping portion, 37—second clamping portion, 40—fastening bolt, 311—partition bar, 100—blade, 200—knife handle, 210—slot, 230—fixing hole, 300—knife handle sheath, 310—engaging groove, 330—through hole, 350—first clamping portion, 370—second clamping portion, 400—fastening bolt, 3110—partition bar.

### DETAILED DESCRIPTION OF EMBODIMENTS

The particular embodiments of the present invention are further described below in conjunction with the accompanying drawings. It is to be noted herein that the description of the embodiments is intended to help understand the present invention, but does not constitute a limitation to the present invention. Furthermore, the technical features involved in the various embodiments of the present invention described below may be combined with each other as long as they do not constitute a conflict with each other.

Embodiment I:

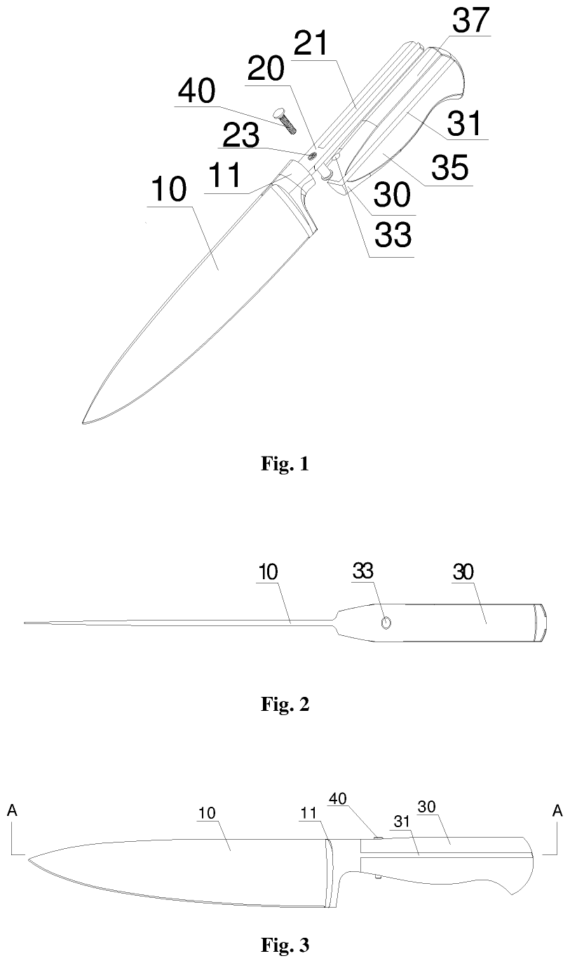

As shown in FIGS. 1-5, in Embodiment I of the present invention, provided is a kitchen knife with an easily replaceable knife handle sheath, with a single bolster knife as an example: the kitchen knife including a blade 10, a knife handle 20, a one-piece integrally formed knife handle sheath 30, and only one fastening bolt 40, wherein a bolster 11 is located between the blade 10 and the knife handle 20; the knife handle 20 is provided with a slot 21, the knife handle sheath 30 includes a first clamping portion 35 and a second clamping portion 37, the first clamping portion 35 and the second clamping portion 37 are connected to each other, and as shown in FIGS. 1-6, the first clamping portion 35 and the second clamping portion 37 are preferably connected at one end away from the blade 10, and obviously they can also be connected at one side; and an engaging groove 31 fitted with the knife handle 20 is provided between the first clamping portion 35 and the second clamping portion 37, and the knife handle 20 is a transverse knife handle as shown in FIG. 1 or a vertical knife handle as shown in FIG. 5.

In Embodiment I, the knife handle 20 is provided with a fixing hole 23 for fixing the knife handle sheath 30, and the fixing hole 23 is internally provided with a thread.

The knife handle sheath 30 is provided with a through hole 33 that is in registration with the fixing hole 23, and the diameter of the through hole 33 is the same as that of the fixing hole 23.

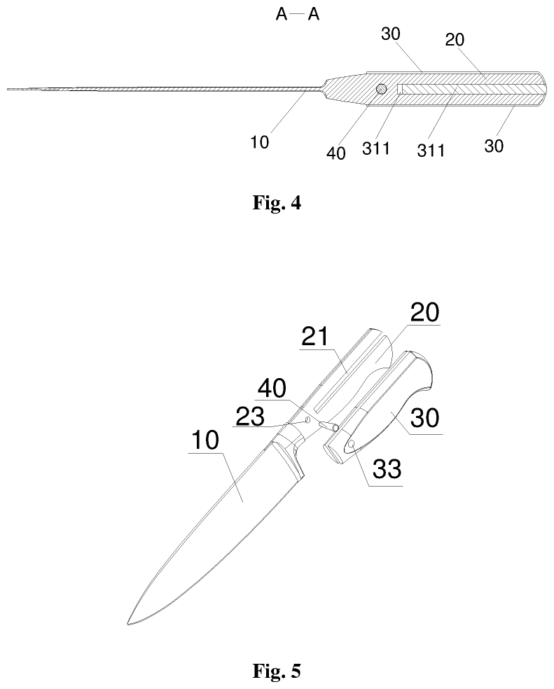

In Embodiment I, as shown in FIGS. 3 and 4, in order to further improve the position accuracy and stability of the mounting of the knife handle sheath 30, a partition bar 311 fitted with the slot 21 is provided in the middle of the engaging groove 31, where the width of the partition bar 311 can be 0.2-1 mm smaller than the width of the slot 21; and when the knife handle 20 is embedded into the engaging groove 31 fitted therewith between the first clamping portion 35 and the second clamping portion 37, the partition bar 311 is clamped by two ends of the slot 21 to fix the knife handle sheath 30. The partition bar 311 also has a guiding function during the fitting and installation of the knife handle sheath 30 and the knife handle 20 and can effectively improve the firmness of the knife handle sheath after installation.

In Embodiment I, as shown in FIGS. 3 and 4, the partition bar 311 is preferably integrally formed with the first clamping portion 35 and the second clamping portion 37. Obviously, the partition bar 311 and the first clamping portion 35 and the second clamping portion 37 may also be separate components and assembled by a fixing manner.

In order to further improve the stability of the knife handle sheath 30, in this embodiment, the single bolster knife further includes only one fastening bolt 40, the fastening bolt 40 passes through the through hole 33 and the fixing hole 23 to fasten the knife handle sheath 30 outside the knife handle 20, and the external thread of the fastening bolt 40 is in threaded engagement with the thread provided in the fixing hole 23.

In Embodiment I, the lengths of the blade 10, the transverse knife handle 20 and the knife handle sheath 30 may be respectively 200 mm, 140 mm and 116 mm, the maximum width of the blade 10 is 2.7 mm, the width of the knife handle sheath 30 is 19 mm, and the distance between the first clamping portion 35 and the second clamping portion 37 is 3.5 mm.

In Embodiment I, the height of the partition bar 311 is also 3.5 mm.

In Embodiment I, the material of the blade 10 and the knife handle 20 is stainless steel or ceramic, and the material of the knife handle sheath 30 is wood, plastic, ceramic, rubber, stainless steel or a G10 composite material (a composite material made of fiberglass and resin by rolling). A knife body is composed of the blade 10 and the knife handle 20, which are integrally connected by the bolster 11.

In Embodiment I, an entire outer peripheral edge surface of the knife handle 20 is flush with an outer surface of the knife handle sheath 30 to form an entire handle with a smooth contour. In Embodiment I, when the knife handle sheath 30 is cleaned, the fastening bolt 40 is first removed; the knife handle sheath 30 is then pulled out from the knife handle 20, and the partition bar 311 is pulled out from the slot 21 at the same time so that the knife handle sheath 30 is separated from the knife handle 20; and finally the knife body is placed in a cleaning apparatus for cleaning. After cleaning, the knife handle sheath 30 is reinstalled, and the fastening bolt 40 is fastened.

When discarded, the fastening bolt 40 is removed; the knife handle sheath 30 is then pulled out from the knife handle 20, and the partition bar 311 is pulled out from the slot 21 at the same time so that the knife handle sheath 30 is separated from the knife handle 20; and finally the knife body and the knife handle sheath 30 are respectively placed in different classification and recycling devices for classification and recycling.

Embodiment II:

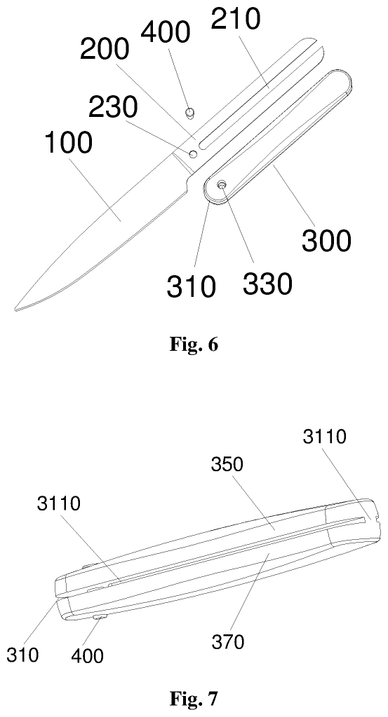

Embodiment II provides a kitchen knife with an easily replaceable knife handle sheath, with a knife with a stamped blade and knife handle structure shown in FIGS. 6 and 7 as an example.

The structure of a knife handle sheath 300 and a knife handle 200 for the knife with a stamped blade and knife handle structure in Embodiment II is the same as the structure of the knife handle sheath 30 and the knife handle 20 of the single bolster knife in Embodiment I.

The knife with a stamped blade and knife handle structure includes a blade 100, a knife handle 200, a one-piece integrally formed knife handle sheath 300, and only one fastening bolt 400; the knife handle 200 is provided with a slot 210, the knife handle sheath 300 includes a first clamping portion 350 and a second clamping portion 370, the first clamping portion 350 and the second clamping portion 370 are connected to each other, and as shown in FIG. 6, the first clamping portion 350 and the second clamping portion 370 are preferably connected at one end away from the blade 100, and obviously they can also be connected at one side; and an engaging groove 310 fitted with the knife handle 200 is formed between the first clamping portion 350 and the second clamping portion 370.

In Embodiment II, in order to further improve the stability of the knife handle sheath 300, the knife handle 200 is provided with a fixing hole 230 and only one fastening bolt 400 for fixing the knife handle sheath 300, the fixing hole 230 is internally provided with a thread, the knife handle sheath 300 is provided with a through hole 330 that is in registration with the fixing hole 230, and the diameter of the through hole 330 is the same as that of the fixing hole 230. The fastening bolt 400 passes through the through hole 330 and the fixing hole 230 to fasten the knife handle sheath 300 outside the knife handle 200, and the external thread of the fastening bolt 400 is in threaded engagement with the thread provided in the fixing hole 230.

In Embodiment II, as shown in FIGS. 6 and 7, in order to further improve the position accuracy and stability of the mounting of the knife handle sheath 300, a partition bar 3110 fitted with the slot 210 is provided in the middle of the engaging groove 310, where the width of the partition bar 3110 can be 0.2-1 mm smaller than the width of the slot 210; and when the knife handle 200 is embedded into the engaging groove 310 fitted therewith between the first clamping portion 350 and the second clamping portion 370, the partition bar 3110 is clamped by two ends of the slot 210 to fix the knife handle sheath 300. The partition bar 3110 also has a guiding function during the fitting and installation of the knife handle sheath 300 and the knife handle 200 and can effectively improve the firmness of the knife handle sheath 300 after installation.

In Embodiment II, as shown in FIGS. 6 and 7, the partition bar 310 is preferably integrally formed with the first clamping portion 350 and the second clamping portion 370. Obviously, the partition bar 3110 and the first clamping portion 350 and the second clamping portion 370 may also be separate components and assembled by a fixing manner.

In Embodiment II, in order to adapt to the requirement of different sizes and designs, the lengths of the stamped blade 100, the stamped knife handle 200 and the knife handle sheath 300 may be respectively 133 mm, 115 mm and 115 mm, the maximum width of the blade 100 is 1.5 mm, the width of the knife handle sheath 300 is 12 mm, and the distance between the first clamping portion 350 and the second clamping portion 370 is 1.5 mm.

In Embodiment II, the materials of the blade 100, the knife handle 200 and the knife handle sheath 300 of the stamping knife may be the same as those of the single bolster knife in Embodiment I.

In Embodiment II, an entire outer peripheral edge surface of the knife handle 200 is flush with an outer surface of the knife handle sheath 300 to form an entire handle with a smooth contour. In Embodiment II, when the knife handle sheath 300 is cleaned, the fastening bolt 400 is first removed; the knife handle sheath 300 is then pulled out from the knife handle 200, and the partition bar 3110 is pulled out from the slot 210 at the same time so that the knife handle sheath 300 is separated from the knife handle 200; and finally the knife body is placed in a cleaning apparatus for cleaning. After cleaning, the knife handle sheath 300 is reinstalled, and the fastening bolt 400 is fastened.

When discarded, the fastening bolt 400 is removed; the knife handle sheath 300 is then pulled out from the knife handle 200, and the partition bar 3110 is pulled out from the slot 210 at the same time so that the knife handle sheath 300 is separated from the knife handle 200; and finally the knife body and the knife handle sheath 300 are respectively placed in different classification and recycling devices for classification and recycling.

For both the kitchen knives in Embodiment I and Embodiment II of the present invention, the knife body can be discarded when the blade is aged, and a new knife body matching with the knife handle sheath is purchased and is installed with the knife handle sheath for use. When the knife handle sheath has a quality problem, the knife handle sheath with the quality problem can be removed and replaced with a new knife handle sheath.

The embodiments of the present invention have been described in detail above in conjunction with the accompanying drawings, but the present invention is not limited to the described embodiments. For those skilled in the art, various changes, modifications, substitutions and variations made to these embodiments still fall within the scope of protection of the present invention without departing from the principles and spirit of the present invention.

1. A kitchen knife with an easily replaceable knife handle sheath, comprising a blade, a knife handle, a one-piece integrally formed knife handle sheath, and only one fastening bolt, wherein the knife handle sheath comprises a first clamping portion and a second clamping portion connected to each other, an engaging groove fitted with the knife handle is provided between the first clamping portion and the second clamping portion, and the knife handle is inserted into and fixed to the engaging groove,
wherein the knife handle is provided with a fixing hole, the knife handle sheath is provided with a through hole which is in registration with the fixing hole, the diameter of the through hole is the same as that of the fixing hole, and the only one fastening bolt passes through the through hole and the fixing hole to fasten the knife handle sheath outside the knife handle.

2. The kitchen knife according to claim 1, wherein the kitchen knife is a single bolster knife or a knife with a stamped blade and knife handle structure.

3. The kitchen knife according to claim 1, wherein the fixing hole is internally provided with a thread; and the only one fastening bolt is provided with an external thread which is in threaded engagement with the thread in the fixing hole.

4. The kitchen knife according to claim 2, wherein the fixing hole is internally provided with a thread; and the only one fastening bolt is provided with an external thread which is in threaded engagement with the thread in the fixing hole.

5. The kitchen knife according to claim 3, wherein the knife handle is provided with a slot, a partition bar fitted with the slot is provided in a middle of the engaging groove, and the partition bar is inserted into the slot to fix the knife handle sheath.

6. The kitchen knife according to claim 4, wherein the knife handle is provided with a slot, a partition bar fitted with the slot is provided in a middle of the engaging groove, and the partition bar is inserted into the slot to fix the knife handle sheath.

7. The kitchen knife according to claim 5, wherein a width of the partition bar is 0.2-1 mm smaller than a width of the slot.

8. The kitchen knife according to claim 6, wherein a width of the partition bar is 0.2-1 mm smaller than a width of the slot.

9. The kitchen knife according to claim 5, wherein the kitchen knife is a single bolster knife, lengths of the blade, the knife handle and the knife handle sheath are respectively 200 mm, 140 mm and 116 mm, the blade has a maximum width of 2.7 mm, the knife handle sheath has a width of 19 mm, and a distance between the first clamping portion and the second clamping portion is 3.5 mm.

10. The kitchen knife according to claim 9, wherein the partition bar has a height of 3.5 mm.

11. The kitchen knife according to claim 1, wherein the kitchen knife is a knife with a stamped blade and knife handle structure, lengths of the blade, the knife handle and the knife handle sheath are respectively 133 mm, 115 mm and 115 mm, the blade has a maximum width of 1.5 mm, the knife handle sheath has a width of 12 mm, and a distance between the first clamping portion and the second clamping portion is 1.5 mm.

12. The kitchen knife according to claim 1, wherein a material of the blade and the knife handle is one of stainless steel or ceramic, and a material of the knife handle sheath is wood, plastic, rubber, stainless steel, ceramic or a G10 composite material.

13. The kitchen knife according to claim 2, wherein a material of the blade and the knife handle is one of stainless steel or ceramic, and a material of the knife handle sheath is wood, plastic, rubber, stainless steel, ceramic or a G10 composite material.

14. The kitchen knife according to claim 1, wherein an entire outer peripheral edge surface of the knife handle is flush with an outer surface of the knife handle sheath to form an entire handle with a smooth contour.

15. A method of replacing a knife handle sheath of a kitchen knife of claim 5, the method comprising:
removing the only one fastening bolt from the through hole and the fixing hole; and
pulling the knife handle sheath out from the knife handle, and thus at the same time pulling the partition bar out from the slot, thereby detaching the knife handle sheath from the knife handle.

16. The method according to claim 15, further comprising:
installing the knife handle sheath or a new knife handle sheath back to the knife handle; and
fastening the knife handle sheath or the new knife handle sheath to the knife handle by the only one fastening bolt.
